(19) United States
(12) Patent Application Publication
(10) Pub. No.: US 2016/0142343 A1
(43) Pub. Date: May 19, 2016

(54) System for Recovery in Channel Bonding

(71) Applicant: Broadcom Corporation, Irvine, CA (US)

(72) Inventors: Anand Tongle, San Diego, CA (US); Rajesh Shankarrao Mamidwar, San Diego, CA (US); Eng Choon Ooi, Singapore (SG); Toon Tun Chiam, Singapore (SG)

(21) Appl. No.: 14/563,253

(22) Filed: Dec. 8, 2014

Related U.S. Application Data
(60) Provisional application No. 62/079,221, filed on Nov. 13, 2014.

(51) Int. Cl. H04L 12/861; H04L 29/06

(52) U.S. Cl. CPC H04L 49/9057; H04L 69/14; H04L 69/22

(57) ABSTRACT

A single stream at a source device may be transmitted over multiple channels. At the input of the channels that packets from the stream may be time stamped. After transmission over the channels, the time stamps may be extracted from the packets. Recovery circuitry, at the destination device, may determine relative timings of the packets within the single stream based on the extracted time stamps. The packets may be released from buffers in accord with the determined relative timings to recreate the relative timings within the single stream at the destination device.

### 1. CROSS REFERENCE TO RELATED APPLICATIONS

This application claims priority to provisional application Ser. No. 62/079,221, filed Nov. 13, 2014, which is entirely incorporated by reference.

### 2. TECHNICAL FIELD

This disclosure relates to audio and video communication techniques. In particular, this disclosure relates to channel bonding for audio and video communication.

### 3. BACKGROUND

Rapid advances in electronics and communication technologies, driven by immense private and public sector demand, have resulted in the widespread adoption of smart phones, personal computers, internet ready televisions and media players, and many other devices in every part of society, whether in homes, in business, or in government. These devices have the potential to consume significant amounts of audio and video content. At the same time, data networks have been developed that attempt to deliver the content to the devices in many different ways. Further improvements in the delivery of content to the devices will help continue to drive demand for not only the devices, but for the content delivery services that feed the devices.

### BRIEF DESCRIPTION OF THE DRAWINGS

FIG. 1 shows an example content delivery architecture.

FIG. 2 shows an example implementation of a splitter.

FIG. 3 shows example distributor circuitry, which may be included within the splitter.

FIG. 4 shows an example implementation of packet reception circuitry.

FIG. 5 shows example recovery circuitry, which may be included within the packet reception circuitry.

FIG. 6 shows example recovery circuitry.

FIG. 7 shows example distributed recovery circuitry.

FIG. 8 shows example recovery logic, which may be implemented on recovery circuitry.

FIG. 9 shows mapping logic for mapping a stream onto a lower data rate channel.

FIG. 10 show example ratio sampling circuitry.

FIG. 11 shows an example implementation of ratio sampling circuitry.

### DETAILED DESCRIPTION

The architectures and techniques discussed below may be used to reconstruct the timing present in an original stream at a source device in a recovered stream at a destination device after the stream is sent over one or more transmission channels. At the input of the transmission channels the packets from the stream are time-stamped. After transmission over the channels, the time stamps may be extracted from the packets and used to reconstruct the relative timings present in the original stream. For example, the packets may be reordered to match the original order of the packets within the original stream. The system may otherwise order the packets, e.g., to respace the packets in time such that the time durations between packets is restored to that of the original stream before transmission.

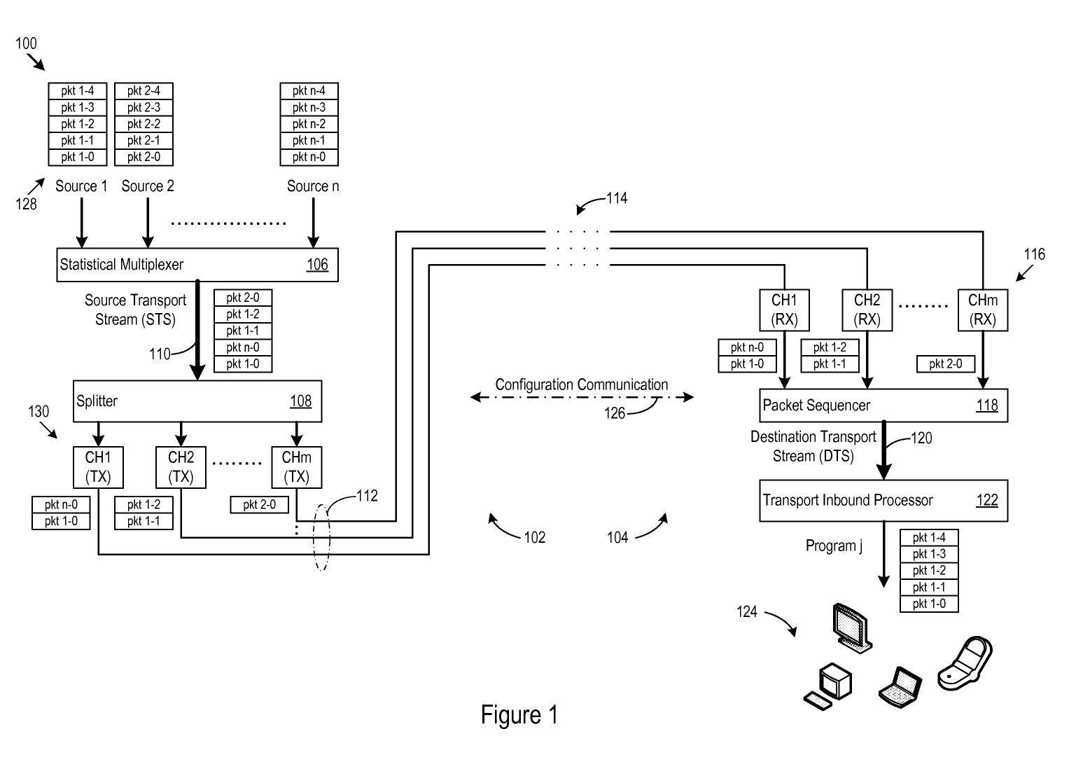

FIG. 1 shows an example content delivery architecture 100. The architecture 100 delivers data (e.g., audio streams and video programs) from a source 102 to a destination 104. The source 102 may include satellite, cable, or other media providers, and may represent, for example, a head-end distribution center that delivers content to consumers. The source 102 may, for example, receive the data in the form of Motion Picture Expert Group 2 (MPEG2) Transport Stream (TS) packets 128, when the data is audio/visual programming. The destination 104 may be a home, business, or other location, where, for example, a set top box processes the data sent by and received from the source 102. The discussion below makes reference to packets, and in some places specific mention is made of MPEG2 TS packets. However, the techniques described below may be applied to a wide range of different types and formats of communication units, whether they are MPEG2 TS packets, packets of other types, or other types of communication units, and the techniques are not limited to MPEG2 TS packets at any stage of the processing.

The source 102 may include a statistical multiplexer 106 and a splitter 108. The statistical multiplexer 106 helps make data transmission efficient by reducing idle time in the source transport stream (STS) 110. In that regard, the statistical multiplexer 106 may interleave data from multiple input sources together to form the transport stream 110. For example, the statistical multiplexer 106 may allocate additional STS 110 bandwidth among high bit rate program channels and relatively less bandwidth among low bit rate program channels to provide the bandwidth needed to convey widely varying types of content at varying bit rates to the destination 104 at any desired quality level. Thus, the statistical multiplexer 106 very flexibly divides the bandwidth of the STS 110 among any number of input sources.

Several input sources are present in FIG. 1: Source 1, Source 2, . . . , Source n. There may be any number of such input sources carrying any type of audio, video, or other type of data (e.g., web pages or file transfer data). Specific examples of source data include MPEG or MPEG2 TS packets for digital television (e.g., individual television programs or stations), and 4K×2K High Efficiency Video Coding (HVEC) video (e.g., H.265/MPEG-H) data, but the input sources may provide any type of input data. The source data (e.g., the MPEG 2 packets) may include program identifiers (PIDs) that indicate a specific program (e.g., which television station) to which the data in the packets belongs.

The STS 110 may have a data rate that exceeds the transport capability of any one or more communication links between the source 102 and the destination 104. For example, the STS 110 data rate may exceed the data rate supported by a particular cable communication channel exiting the source 102. To help deliver the aggregate bandwidth of the STS 110 to the destination 104, the source 102 includes a splitter 108 and modulators 130 that feed a bonded channel group 112 of multiple individual communication channels. In other words, the source 102 distributes the aggregate bandwidth of the STS 110 across multiple outgoing communication channels that form a bonded channel group 112, and that together provide the bandwidth for communicating the data in the STS 110 to the destination 104.

In that regard, the multiple individual communication channels within the bonded channel group 112 provide an aggregate amount of bandwidth, which may be less than, equal to, or in excess of the aggregate bandwidth of the STS 110. As just one example, there may be three 30 Mbs physical cable channels running from the source 102 to the destination 104 that handle, in the aggregate, up to 90 Mbs or more. The communication channels in the bonded channel group 112 may be any type of communication channel, including dial-up (e.g., 56 Kbps) channels, ADSL or ADSL 2 channels, coaxial cable channels, wireless channels such as 802.11a/b/g/n channels or 60 GHz WiGig channels, Cable TV channels, WiMAX/IEEE 802.16 channels, Fiber optic, 10 Base T, 100 Base T, 1000 Base T, power lines, or other types of communication channels.

The bonded channel group 112 travels to the destination 104 over any number of transport mechanisms 114 suitable for the communication channels within the bonded channel group 112. The transport mechanisms 144 may include physical cabling (e.g., fiber optic or cable TV cabling), wireless connections (e.g., satellite, microwave connections, 802.11 a/b/g/n connections), or any combination of such connections.

At the destination 104, the bonded channel group 112 is input into individual channel demodulators 116. The channel demodulators 116 recover the data sent by the source 102 in each communication channel. A packet sequencer 118 collects the data recovered by the demodulators 116, and may create a destination transport stream (DTS) 120. The DTS 120 may be one or more streams of packets recovered from the individual communication channels as sequenced by the packet sequencer 118.

The destination 104 also includes a transport inbound processor (TIP) 122. The TIP 122 processes the DTS 120. For example, the TIP 122 may execute program identifier (PID) filtering for each channel independently of other channels. To that end, the TIP 122 may identify, select, and output packets from a selected program (e.g., a selected program ‘j’) that are present in the DTS 120, and drop or discard packets for other programs. In the example shown in FIG. 1, the TIP 122 has recovered program ‘j’, which corresponds to the program originally provided by Source 1. The TIP 122 provides the recovered program to any desired endpoints 124, such as televisions, laptops, mobile phones, and personal computers. The destination 104 may be a set top box, for example, and some or all of the demodulators 116, packet sequencer 118, and TIP 122 may be implemented as hardware, software, or both in the set top box.

The source 102 and the destination 104 may exchange configuration communications 126. The configuration communications 126 may travel over an out-of-band or in-band channel between the source 102 and the destination 104, for example in the same or a similar way as program channel guide information, and using any of the communication channel types identified above. One example of a configuration communication is a message from the source 102 to the destination 104 that conveys the parameters of the bonded channel group 112 to the destination 104.

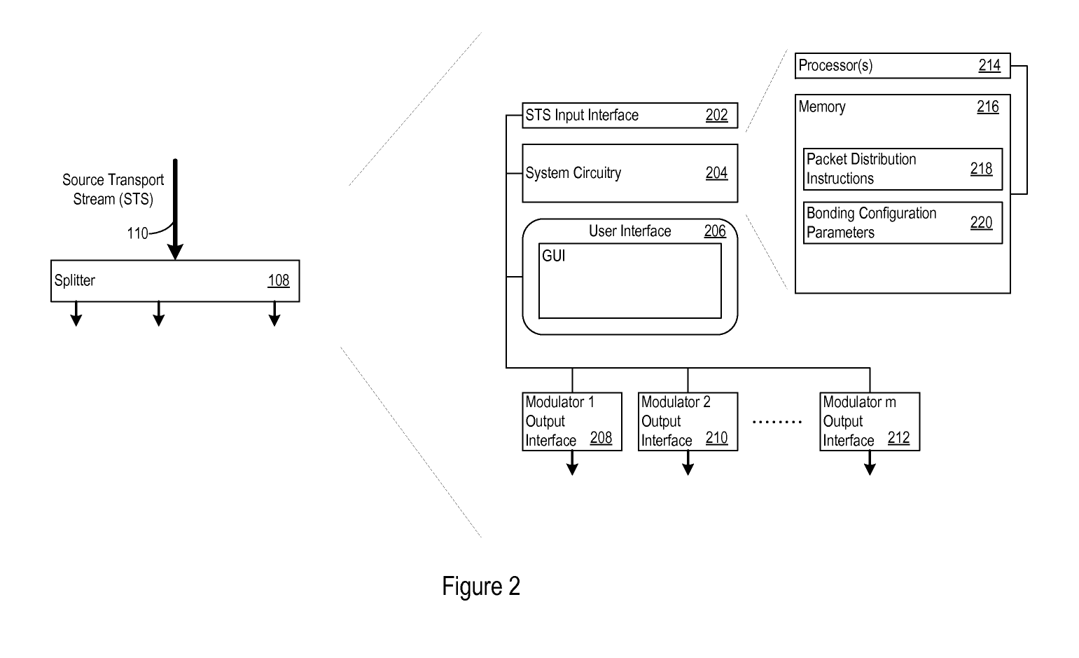

Turning now to FIG. 2, the figure shows an example implementation of a splitter 108. The splitter 108 includes an STS input interface 202, system circuitry 204, and a user interface 206. In addition, the distributor 200 includes modulator output interfaces, such as those labeled 208, 210, and 212. The STS input interface 202 may be a high bandwidth (e.g., optical fiber) input interface, for example. The modulator output interfaces 208-212 feed data to the modulators that drive data over the communication channels. The modulator output interfaces 208-22 may be serial or parallel bus interfaces, as examples.

The system circuitry 204 implements in hardware, software, or both, any of the circuitry described in connection with the operation of the splitter 108. As one example, the system circuitry 204 may include one or more processors 214 and program and data memories 216. The program and data memories 216 hold, for example, packet distribution instructions 218 and the bonding configuration parameters 220.

The processors 214 execute the packet distribution instructions 218, and the bonding configuration parameters 220 inform the processor as to the type of channel bonding the processors 214 will perform. The distributor 200 may accept input from the user interface 206 to change, view, add, or delete any of the bonding configuration parameters 220 or any channel bonding status information.

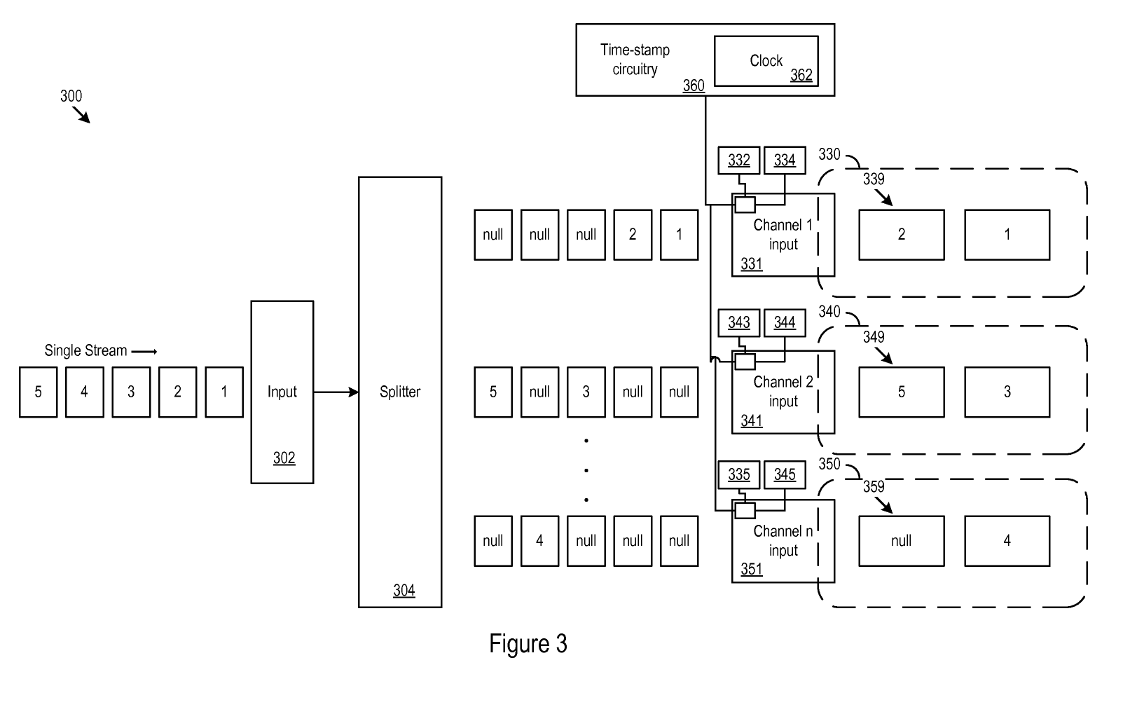

FIG. 3 shows example distributor circuitry 300, which may be included within the splitter 108. The example distributor circuitry may include an input 302 for receiving an input stream. The input stream may be a single multiplexed stream. For example, the multiplexed stream may be the result of statistical multiplexing. The input 302 may be in data communication with splitter circuitry 304. The splitter circuitry may distribute the packets 339, 349, 359 of the input stream to the various ones of multiple channels 330, 340, 350 for transmission. For example, the splitter may apply a round robin distribution scheme to distribution the packets 339, 349, 359 over the multiple channels 330, 340 350. However, other distribution schemes may be applied.

The splitter circuitry may provide packets to the individual channels such that the data rate of the channel may be proportionally less than that of the multiplexed stream. For example, in a system with three transmission channels, e.g., a bonded channel group of three channels, the transmission channel may individually support transmission at a third the rate of the multiplexed stream or faster. For example, the splitter circuitry may insert NULL packets into channels not receiving a stream packet for a given symbol count. For example, in a three channel system when a packet from the stream is distributed to one channel, NULL packets may be placed in the other two channels. When the data is modulated onto a symbol stream at the channel symbol rate, which may be a fraction of the single stream symbol rate. The modulated packet may expand into the time-space occupied by the NULL packets. Other processes for generating time-space used for the expansion of the modulated packets.

The inputs 331, 341, 351 of the various channels may be in communication with time-stamp circuitry 360. The time-stamp circuitry may include a clock 362 that provides the same clock signal to the three channels. Thus, the channels are synchronized by a common clock. The time-stamp circuitry may provide time stamps to the packets when they are received at the inputs of the individual transmission channels. For example, the time stamps may be appended to the packets, added to a field in the packet header, added to a field in the payload, sent with metadata or configuration data for the bonded stream, and/or otherwise appended to the packet. The common clock, may also be used to ensure that relative timings of packets within the single input stream are recorded within the time-stamps. In some implementations, the common clock may operate at the symbol rate of the primary band of a bonded channel group.

The channels 330, 340, 350 may further include processing 332, 342, 352 and coding circuitry 334, 344, 345 to support transmission of the packets over the transmission medium. For example, the coding circuitry 334, 344, 354 may include error coding circuitry to supply coding gain for signal robustness during transmission. Further, the coding circuitry 334, 344, 354 may include symbol coding to encode the packets for transmission over the channel. The processing circuitry 332, 342, 352 may provide a channel clock signals to support transmission at the data rate of the channels.

In an example scenario, the channels may include 2^{nd} Generation Digital Video Broadcasting-Satellite, Extension (DVB-S2X) bonded channels. The common clock signal may include input stream synchronizer (ISSY) values, which may be appended to the packets as time stamps upon distribution to the individual channels from the single input stream.

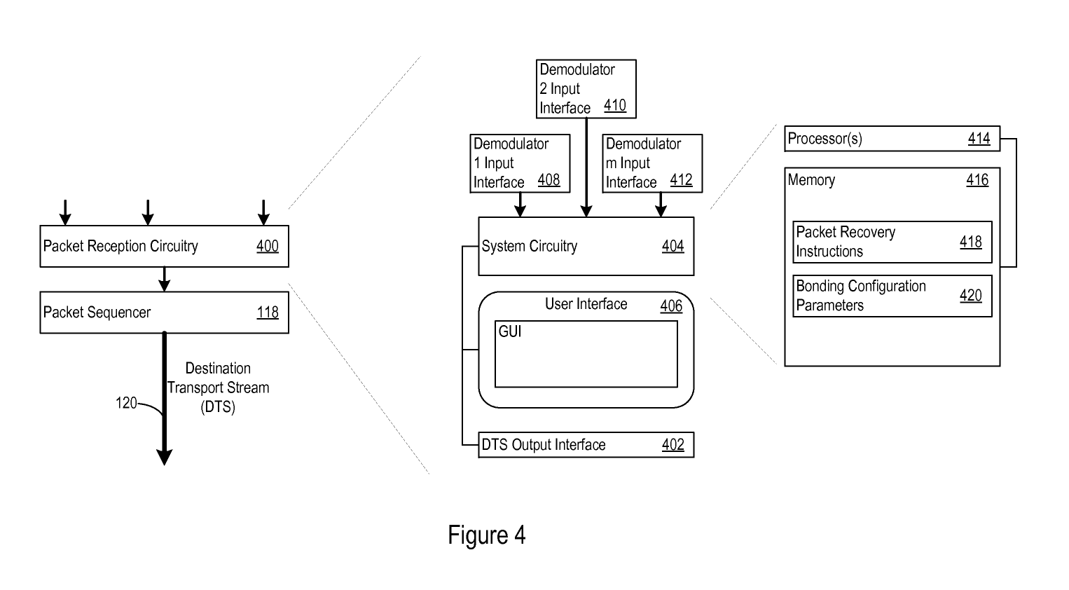

FIG. 4 shows an example implementation of packet reception circuitry 400. The packet reception circuitry 400 includes a DTS output interface 402, system circuitry 404, and a user interface 406. In addition, the collator 400 includes demodulator input interfaces, such as those labeled 408, 410, and 412. The DTS output interface 402 may be a high bandwidth (e.g., optical fiber) output interface to the TIP 122, for example. The demodulator output interfaces 408-412 feed data to the collator system circuitry which will create the DTS 120 from the data received from the demodulator input interfaces 408-412. The demodulator input interfaces 408-412 may be serial or parallel bus interfaces, as examples.

The system circuitry 404 implements in hardware, software, or both, any of the circuitry described in connection with the operation of the packet reception circuitry 400. As one example, the system circuitry 404 may include one or more processors 414 and program and data memories 416. The program and data memories 416 hold, for example, packet recovery instructions 418 and the bonding configuration parameters 420.

The processors 414 execute the packet recovery instructions 418, and the bonding configuration parameters 420 inform the processor as to the type of channel bonding the processors 414 will handle. The collator 400 may accept input from the user interface 406 to change, view, add, or delete any of the bonding configuration parameters 420, to specify which channels are eligible for channel bonding, or to set, view, or change any other channel bonding status information.

The architectures described above may also include network nodes between the source 102 and the destination 104. The network nodes may be type of packet switch, router, hub, or other data traffic handling circuitry. In concert with the above, the channel bonding may happen in a broadcast, multicast, or even a unicast environment. In the broadcast environment, the source 102 may send the program packets to the endpoints attached to the communication channels, such as in a wide distribution home cable service. In a multicast environment, however, the source 102 may deliver the program packets to a specific group of endpoints connected to the communication channels. In this regard, the source 102 may include addressing information, such as Internet Protocol (IP) addresses or Ethernet addresses, in the packets to specifically identify the intended recipients. In the unicast environment, the source 102 may use addressing information to send the program packets across the bonded channel group 112 to a single destination.

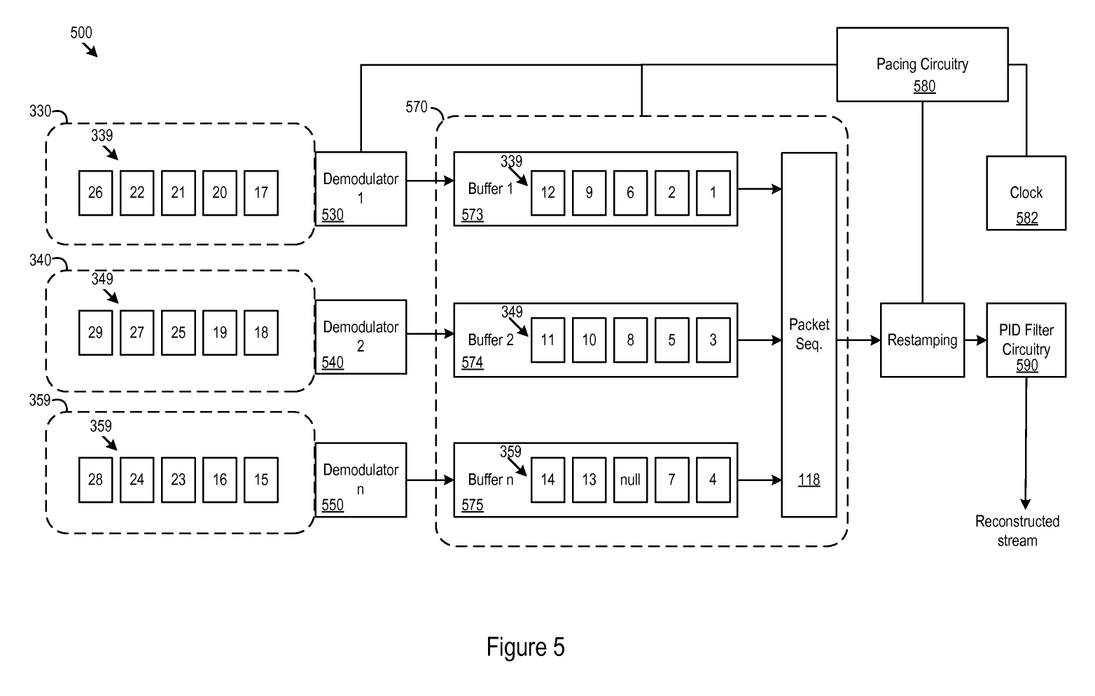

FIG. 5 shows example recovery circuitry 500, which may be included within the packet reception circuitry 400. The collator circuitry may include demodulators 530, 540, 550 for the channels 330, 340, 350.

The demodulators 530, 540, 550 may parse the signal on the channels 330, 340, 350 into received packets 339, 349, 359. The demodulators 530, 540, 550 may further perform clock recovery to recover the channel clocks for the channels 330, 340, 350. Recovering the channel clocks allows for timing synchronization with the distributor circuitry at the source. The channel clocks may include a periodic signal indicating a timing rate associated with signaling on the channel.

The demodulators may pass the parsed packets to buffer circuitry 570 for buffering the received packets during the recovery process for the single stream sent over the channels. The buffer circuitry may include buffers 573, 574, 575 paired with channels 330, 340, 350, such that packets received on different channels may be placed in separate queues. Within individual channels, the packets sent first on the channel arrive before subsequent packets sent on the channel. However, among different channels, a packet sent on a first channel prior to a second packet sent on a second channel may arrive after the second packet. Thus, to recreate the timing relationship of the packets, the second packet may be held in a buffer until the first packet is received and released from the buffer for the first channel.

The pacing circuitry 580 may extract the time-stamps from the packets 339, 349, 359 received on the channels 330, 340, 350. The pacing circuitry may read the time stamps a determine when to cause the buffers 573, 574, 575, to release packets to recreate a relative timing of the packets within the single input stream at the input 302 of the distributor circuitry 300.

In some implementations, the pacing circuitry 380 may reorder the received packets 339, 349, 359 according to the original order of the packets within the single input stream at the input 302 of the distributor circuitry 300. To reorder the packets, the pacing circuitry 580 may determine which buffer 573, 574, 575 holds the oldest packet according to the time-stamps of the packets within the buffers 573, 574, 575. In response, the pacing circuitry 580 may cause that buffer to release its packet. Individually, the channels 330, 340, 350 may act as first-in first-out (FIFO) systems, the pacing circuitry need only compare the packets at the front of the buffers queues to recreate the order in the single stream.

The pacing circuitry 580 may further recreate the time durations between packets within the single stream. The pacing circuitry 580 may receive one or more of the recovered channel clocks from the demodulators 530, 540, 550. The pacing circuitry 580 may use the recovered channel clocks to translate the time stamps within the packets to the original timing for the packets in the single stream at the source 102. The pacing circuitry may then cause the buffers 573, 574, 575 to release the packets 339, 349, 359 in accord with the time stamped values extracted from the packets 339, 349, 359 scaled in accord with the recovered channel clock signal.

Once, the time durations are recreated, the released packets may be restamped using a local free running clock signal from a local clock 582. The restamping may be used to facilitate the preservation of the time durations during local processing at the destination 104.

Following reordering and/or local restamping, the packets may be filtered according to packet identifiers (PIDs) at the PID filter circuitry 590. The PIDs associated with programs being executed/used at the destination 104 may be passed and unused program packets may be filtered. For example, the PID of a data packet may identify a program assignment for the data packet.

In an example scenario, the recovery circuitry 500 may be applied in a DVB-S2X system. In the example scenario, the input stream synchronization field (ISCR) value of the first oldest received packet (first packet released from a buffer) may be used to initialize the local clock 582. For example, the local clock 582 may start counting from the first ISCR value, or treat the first ISCR value as an origin or zero-point. The rest of the received packets are released only when their ISCR values match with the locally clock 582. As the packet timing matures, locally free running Arrival Timestamp (ATS) counter snapshots may be taken and attached to the packets as they are released. For some reconstructed video streams, the timing between the program clock reference (PCR) packets may be the same after the recovery process as it was within the single stream at the source. Further, the timing is presented in terms of the local free-running clock signal.

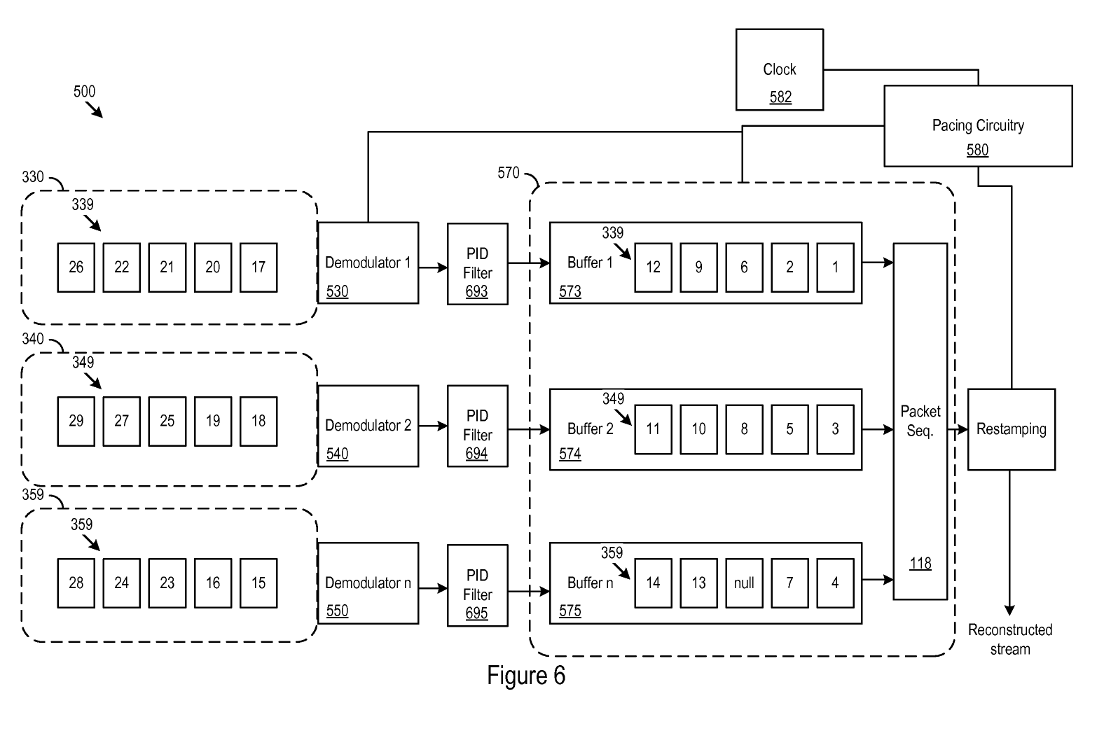

FIG. 6 shows another example of recovery circuitry 600. In the example recovery circuitry 600, the PID filter circuitry 693, 694, 695 may be applied to the individual channels prior to recreation of the single stream. Filtering at this earlier point may reduce the storage space used by the buffers 573, 574, 575. Further, the pace at which packets are released may be reduced. Thus, the recovery circuitry may operate at a lower data rate than that of the single stream at the source.

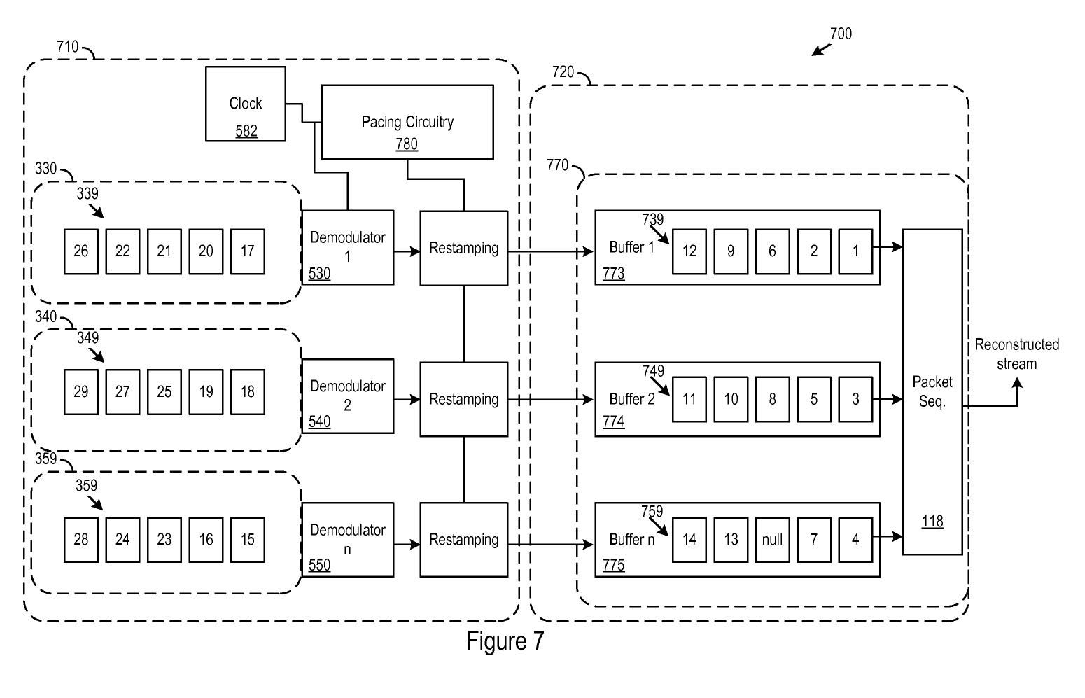

FIG. 7 shows example distributed recovery circuitry 700. The distributed recovery circuitry 700 may be implemented on the frontend 710 and backend 720 of the destination 104. In some cases, the backend may have more memory capacity than the frontend. For example, a backend may include dynamic random access memory (DRAM) memory banks. DRAM memory banks and/or other backend memory types may allow for low cost high-capacity buffers. High capacity buffers may allow for correction of correspondingly large channel skews. For example, in a bonded channel group where one channel has a large latency and other channels have small latencies. The channels with small latencies may deliver many packets sent after packets sent on the channel with the large latency. The buffers on the low latency channels may fill before the oldest packets on these channels can be released because the pacing circuitry 580 may wait for the high latency channel. Packets may be lost once the buffers fill. Thus, larger buffers allow for larger skew correction without packet loss.

In the example, distributed recovery circuitry 700, the pacing circuitry 780 may receive the recovered clock signals from the demodulators 530, 540, 550 in the frontend 710. The pacing circuitry 780 may receive the local free-running clock signal. The pacing circuitry 780 may extract the time stamps from the received packets 339, 349, 359. The pacing circuitry may then compare the recovered clock signal, the time stamp values extracted from the packets, and the local free-running clock signal to translate the extracted time stamp values into restamped local time values. Once the translation is completed, the pacing circuitry 780 may send the restamped received packets 739, 749, 759 to the buffer circuitry 770 disposed in the backend 720. Thus, the restamping may occur prior to reordering or retiming the received packets. The restamped packets may be held in the buffers 773, 774, 775 until the local free-running clock signal reaches the restamped value. Once the restamped value is reached, the buffer circuitry may release the corresponding packet 739, 749, 759 from the packet's buffer 773, 774, 775. Release based on the restamped values may result in reconstruction of the single stream from the source 102.

In distributed recovery circuitry 700 where the time-stamp translation occurs at the frontend 710 prior to backend 720 buffering, pin layouts for the free running clock signal routing may be implemented without complexities that may lead to performance losses. For example, if the timing recovery is performed in the backend, clocks may be routed from the frontend to the backend. In cases where timestamp translation occurs at the frontend prior to recovery at the backend, the number of pins at the periphery of the frontend and backend chips that are used to route the clocks may be fewer than the number used when timestamp translation is not performed at the frontend.

In an example scenario, the recovery circuitry 500, 600, 700 may use an ISSY values to reconstruct single stream. In DVB-S2X systems, the ISSY value may be 22 bits long. However, different ISSY bit values may be used. The rollover time of ISSY value may be less than the total skew between the bands. For example, for a 75 M-symbols per second (Msps) rate and a constellation of 64 amplitude and phase shift keying (64-APSK) values, the total rollover time for 22 bit value may be about 56 msec. However, different symbol rates, constellations, and/or signaling parameters may be used. The recovery circuitry 500, 600, 700 may drop data from some channels until the data from the channels causing the delay is within the allowed skew. Once the buffered channel data is within the allowed skew, the pacing circuitry may allow release of the oldest packet according to ISSY value.

However, varying signaling parameters may allow other allowed skews between channels. For example, adding bits to the ISSY value may increase the time to rollover. Systems utilizing large buffers, for example those capable of holding more than that supported by an ISSY value, may use additional timing fields to expand the rollover timing. For example, distributed recovery circuitry using DRAM buffers may allow for seconds or more of skew time between channels.

If the two channels are present packets with the same time stamp values, the recovery circuitry 500, 600, 700 may parse the PID values of the packets. NULL packets that may have been added at the source 102 or destination 104 for timing reasons may be dropped. In some implementations, once a non-NULL packet is found, other packets with duplication time-stamps may be dropped, even those with differing PID values. Additionally or alternatively, packets with different PID values but identical time-stamps may be released from the buffer in adjacent timing slots.

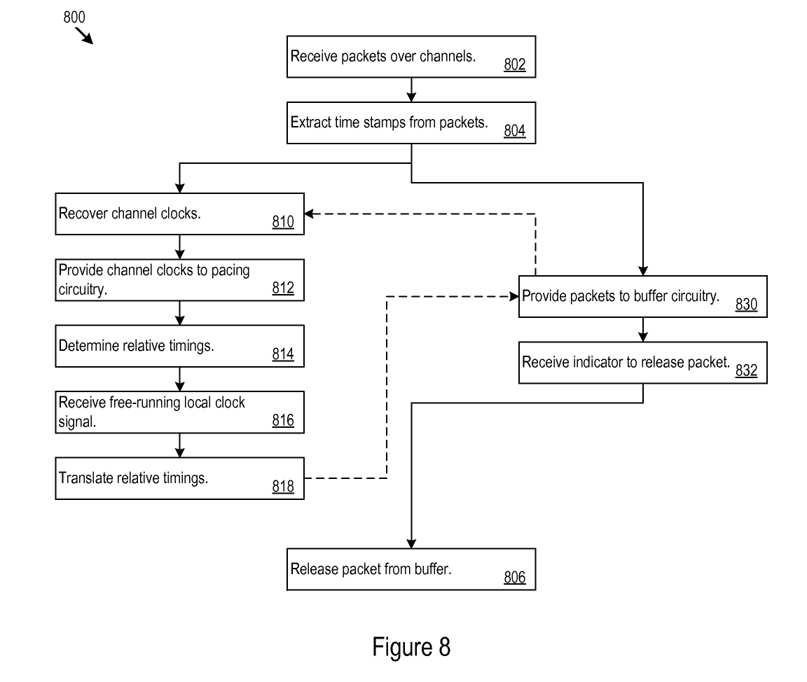

FIG. 8 shows example recovery logic 800, which may be implemented on recovery circuitry 500, 600, 700. The demodulators 530, 540, 550 may receive packets over the channels (802). The pacing circuitry 580, 780 may extract time-stamps from the received packets (804). The demodulators may recover the channel clocks to support synchronization between the source 102 and destination 104 (810). The demodulators may provide the channel clocks to the pacing circuitry 580, 780 (812). Based on the extracted time-stamp and/or the recovered channel clock, the pacing circuitry may determine the relative timings for the received packets (814). For example, the pacing circuitry may determine that order in which the packets should be released from buffering to reconstruct the order of the single stream at the source. Additionally or alternatively, the pacing circuitry may determine the timing between the packets based on the recovered clock and the time stamps. Based on the determined timings the pacing circuitry 580, 780 may determine when, relative to each other, the packets should be released from buffering. The pacing circuitry 580, 780 may receive a local free-running clock signal from a local clock 582 (816). The pacing circuitry may use the local free-running clock signal to translate the relative timings of the packets in to timings in terms of the local clock 582 (818). For example, the packets may be restamped as they are released from the buffers with reconstructed relative timing or the packets may be restamped prior to buffering and released from buffering according to the restamped values.

The demodulators 530, 540, 550 may provide the packets to the buffer circuitry 570, 770 (830). The buffer circuitry 570, 770 may receive an indicator to release a packet from the buffers 573, 574, 575, 773, 774, 775 (832). For example, the buffer circuitry may release a packet when the local time equals the restamped time for the packet applied by the pacing circuitry. Alternatively, the pacing circuitry may send a direct indicator to the buffer circuitry signaling release of a packet from one or more of the buffers.

The buffer circuitry may release the indicated packet (806). The release of the indicated packet reconstructs the relative timing of the packets at the source 102 locally at the destination 104.

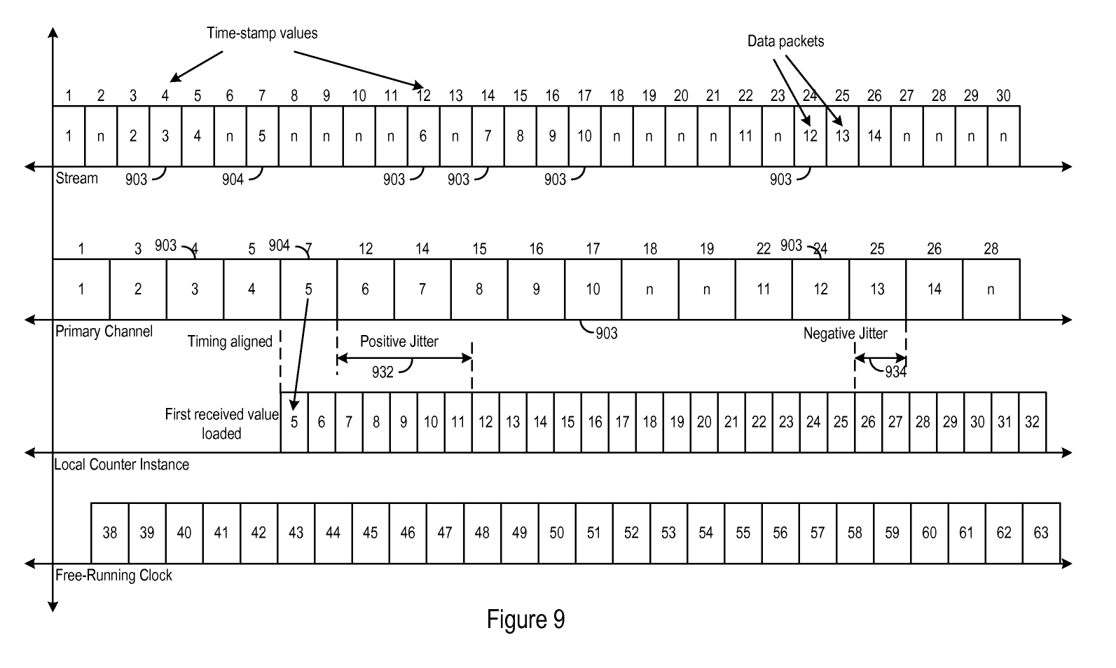

FIG. 9 shows mapping logic 900 for mapping a stream onto a lower data rate channel; the logic 900 may be implemented on circuitry. The mapping logic 900 may be used in the extraction of time-stamp values at the destination 104. Further, the values may be compared to the local clock to facilitate the translation into local time-stamp values.

Time stamp values 902 are assigned to packets 903, 904 in the single stream 910 at the destination 104. A portion of the packets 903, 904 are coded onto a first channel. A first packet 903 is received at the destination 104. The time-stamp value for the first received packet may be used to initialize the local time-stamp-extraction process. The time-stamp-extraction counter then may be aligned with the time-stamp counter at the source 102.

If the received ISSY values are not compared with the locally running ISSY counter at the receiver, jitter may affect the time stamp extraction process. For example, in some cases packets may be distributed to channels unevenly due to signaling, performance, or parameter differences. Time-stamp jitter may occur if symbol arrives before 932 or after 934 its expected arrival time based on the recovered clock. However, if the jitter is computed and adjusted in terms of the timestamp counters, then adjusted timestamps may represent the timing between the packets in the single stream at the source. The timing may then be translated in terms of the local free-running clock at the destination 104.

The adjustment may be performed using the following relation:

$${AT}_{N} = {T}_{N} + ( {ET}_{N} - {LT}_{N} ) \cdot ( \frac{T}{I} ) \qquad Equation 1$$

T_{N} is the sampled value of the local free running clock. For example, the clock value may be sampled at the constant point within the packets. In some implementations, the constant point may occur at a SYNC symbol at the beginning of a packet. LT_{N} is the sampled value of the local synchronized instance of the timestamp counter, which may aid in the extraction of time stamp values. ET_{N} is the extracted value of the time-stamp. The ratio,

$$( \frac{T}{I} ) ,$$

may be determined using ratio sampling circuitry 1000, as described below.

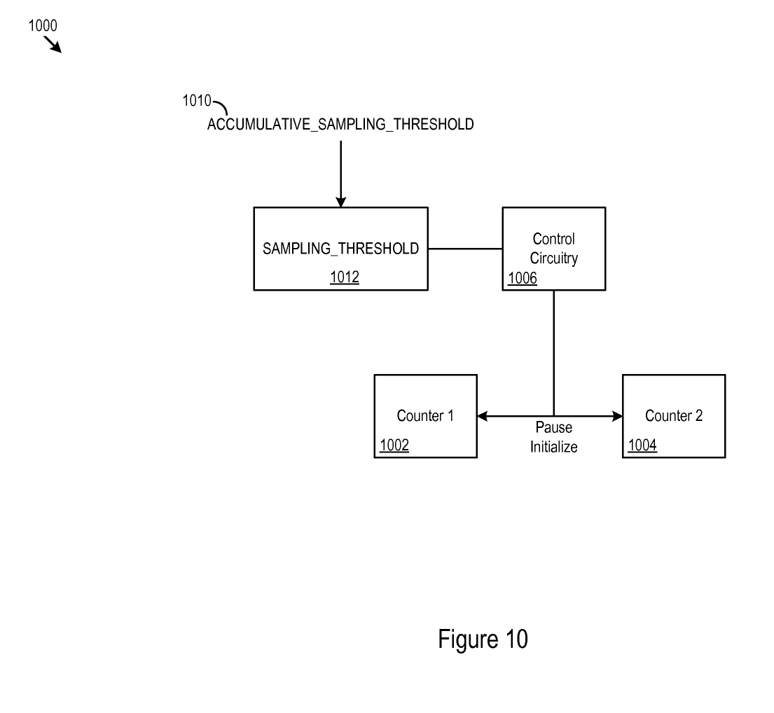

FIG. 10 show example ratio sampling circuitry 1000. The circuitry 1000 may include a first counter 1002 operating at the rate of the local clock 582. The circuitry may also include a second counter 1004 running at the clock rate of one of the channels. For example, a recovered clock from the primary band of a bonded channel group may be used. The counters may be initiated at the same time by the control circuitry 1006. To distribute sampling error across a large sample, the counters may run for long period. For example, the counters may be run until a first one of the counters increments a determined bit value. For example, in a 32-bit counter system, the counters may run until the first counter increments the 4^{th}, 8^{th}, 16^{th}, 32^{nd} or other bit value. Alternatively, the counters may run until reaching a threshold. Further, the counters may run until one of the counters reaches a maximum value for the counter's assigned bit depth. The counter values are compared after running for the period to determine ratio. For example, a division operation may be used to calculate the ratio. When, the counter reaches its stopping value, the control circuitry 1006 may pause the other counter to facilitate the comparison.

Intermediate values of the counters may be sampled to reduce channel change times. For example, intermediate ratios may be computed. For example, multiple accumulative sampling thresholds may be loaded in to a sampling register to create successive stopping points. When a channel is initialized, an ACCUMULATIVE_SAMPLING_THRESHOLD value 1010 may be loaded into a local SAMPLING_THRESHOLD register 1012. When one of the counters 1002, 1004 reaches the SAMPLING_THRESHOLD, the value of both the counters may be sampled and the ratio may be provided for computing the adjusted timestamps. The ACCUMULATIVE_SAMPLING_THRESHOLD 1010 may be added to the existing SAMPLING_THRESHOLD register 1012 value.

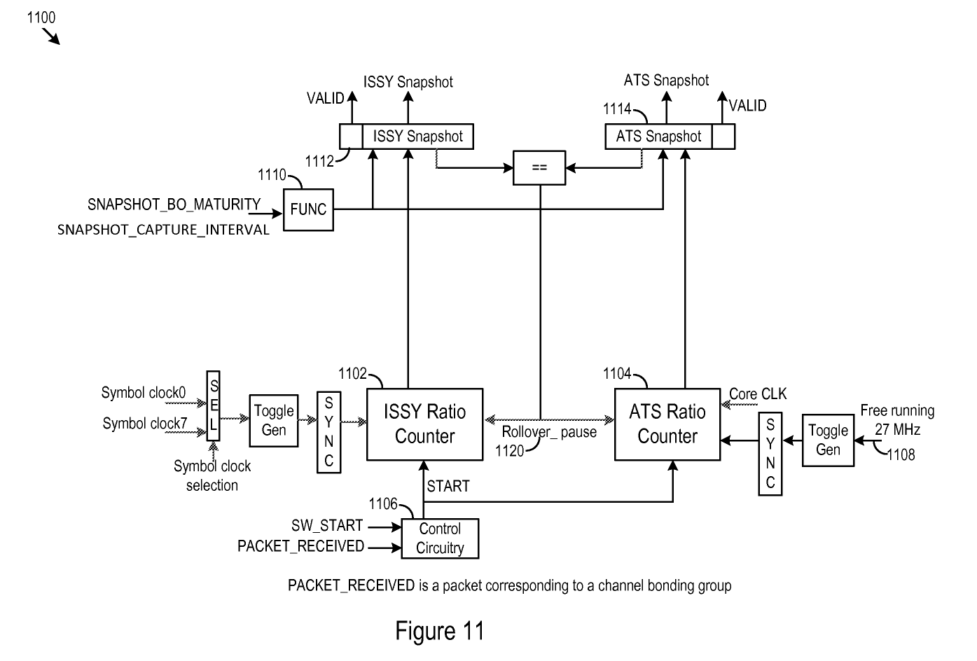

FIG. 11 shows an example implementation of ratio sampling circuitry 1100. The example implementation uses an ISSY ratio counter 1102 based on a recovered symbol clock, from a selectable channel 1106. The example implementation compares the ISSY ratio counter 1102 to an ATS ratio counter 1104 based on a free-running local clock 1108, e.g., a 27 MHz signal. In an example implementation, the ISSY counter and ATS counters may be 32-bit counters. The FUNC block 1110, may monitor the counters 1102, 1104 to determine when the SAMPLING_TRESHOLD is reached by one of the counters and send a pause signal to the counters for determination of the ratio. In the ratio sampling circuitry 1100, the ISSY SNAPSHOT 1112 may include a register which captures the snapshot value of the ISSY counter 1102 when triggered at the end of the SNAPSHOT_CAPTURE_INTERVAL. ATS SNAPSHOT 1114 may include a register which captures the snapshot value of the ATS counter 1104 when triggered at the end of the SNAPSHOT_CAPTURE_INTERVAL. For example, when the captured snapshot value matches or exceeds the capture interval values from the FUNC block 1110. The RollOver_pause signal 1120 may be initiated to pause the counters after the capture intervals mature.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

Various implementations have been specifically described. However, many other implementations are also possible.

What is claimed is:

1. A method comprising:
receiving a first packet over a first channel and a second packet over a second channel different from the first channel, the first and second packet originating from a single stream, the first and second packet having a relative timing within the single stream;
buffering the first packet in a first buffer;
buffering the second packet in a second buffer;
extracting a first time stamp from the first packet, the first time stamp applied by a symbol clock when the first packet was received at an input for distribution to first channel from the single stream;
extracting a second time stamp from the second packet, the second time stamp applied also by the symbol clock when the second packet was received at an input o for distribution to second channel from the single stream;
based on the first time stamp, releasing the first packet from the first buffer; and
based on the second time stamp, releasing the second packet from the second buffer, the release of the packets from the buffers recreating the relative timing.

2. The method of claim 1, wherein the relative timing comprises a relative order of the first and second packets.

3. The method of claim 1, wherein the relative timing comprises a time duration between the first and second packets.

4. The method of claim 1, wherein:
the first and second channels comprise channels within a bonded group; and
the symbol clock comprises an input stream synchronizer for the bonded group.

5. The method of claim 1, wherein the single stream comprises a multiplexed program stream comprising a first program and a second program.

6. The method of claim 5, further comprising filtering the first program out of the multiplexed program stream before an input of the first buffer.

7. The method of claim 5, further comprising filtering the first program out of the multiplexed program after an output of the first buffer.

8. A device comprising:
input interface circuitry configured to receive a first packet over a first channel and second packet over a second channel, the first and second packets from a single stream;
buffer circuitry configured to:
store the first packet; and
store the second packet; and
recovery circuitry configured to:
extract a first time stamp from the first packet, the first time stamp applied by a symbol clock when the first packet was received for distribution to the first channel.
extract a second time stamp from the second packet, the second time stamp applied by the same symbol clock when the second packet was received for distribution to the second channel;
responsive to the first and second time stamps, determine a relative timing for the first and second packets that existed within the single stream; and
cause the buffer circuitry to release the first and second packets to recreate the relative timing.

9. The device of claim 8, wherein the recovery circuitry is configured to determine a relative order of the first and second packets within the single stream to determine the relative timing.

10. The device of claim 8, wherein the recovery circuitry is configured to determine a time duration between the first and second packets to determine the relative timing.

11. The device of claim 10, wherein the recovery circuitry is further configured to:
produce a free-running clock signal; and
determine the time duration in terms of clock cycles of the free-running clock signal.

12. The device of claim 8, further comprising a program filter to filter packets based on a first packet identifier associated with a first program.

13. The device of claim 12, wherein the program filter is disposed between the buffer circuitry and the input interface circuitry.

14. The device of claim 12, wherein the program filter is disposed after an output of the buffer circuitry.

15. The device of claim 8, wherein:
the input interface circuitry comprises demodulator circuitry, the demodulator circuitry configured to:
recover a channel clock for the first channel; and
send the recovered channel clock to the recovery circuitry; and
the recovery circuitry further configured to determine the relative timing responsive to the recovered channel clock.

16. The device of claim 8, wherein:
the buffer circuitry is disposed on backend circuitry of a destination device; and
the recovery circuitry is further configured to:
responsive to the determined relative timing, restamp the first packet based on a free-running clock before sending the first packet to the buffer circuitry; and
responsive to the determined relative timing, restamp the second packet based on a free-running clock before sending second first packet to the buffer circuitry, where the restamped packets are released by the buffer circuitry in accord with the determined relative timing.

17. A system comprising:
input interface circuitry configured to:
receive a first packet via a first channel of a bonded channel group, the first packet from a single stream distributed sent over the bonded channel group;
receive a second packet via a second channel of the bonded channel group, the second packet from the single stream;
recover a channel clock signal from the bonded channel group;
buffer circuitry in data communication with the input interface circuitry, the buffer circuitry configured to:
store the first packet; and
store the second packet; and
stream recovery circuitry configured to:
extract a first time stamp from the first packet, the first time stamp applied by a symbol clock when the first packet was received for distribution to the first channel;
extract a second time stamp from the second packet, the second time stamp applied also by the symbol clock when the second packet was received for distribution to the second channel;
responsive to the first and second time stamps, determine a relative order for the first and second packets that existed within the single stream;
responsive to the determined relative order, cause the buffer circuitry to release the first packet before the buffer circuitry releases the second packet;
responsive to the first and second time stamps and the recovered channel clock, determine a time duration between first and second packets that existed within the single stream; and
cause the buffer circuitry to hold the second packet until the time duration has elapsed after release of the first packet.

18. The system of claim 17, wherein the stream recovery circuitry is configured to restamp the first and second packets in accord with the relative order and the time duration to cause the buffer circuitry to hold the second packet.

19. The system of claim 18, wherein the stream recovery circuitry is configured to restamp the first and second packets before the first and second packets are sent to the buffer circuitry.

20. The system of claim 18, wherein:
the system further comprises a local clock configured to produce a free-running clock signal; and
the stream recovery circuitry is configured to restamp the first and second packets based on the free-running clock signal.
